(19) United States
(12) Patent Application Publication
(10) Pub. No.: US 2015/0017596 A1
(43) Pub. Date: Jan. 15, 2015

(54) THERMOPLASTIC-BASED MATERIALS IN ORTHODONTIC APPLICATIONS

(71) Applicant: Ormco Corporation, Orange, CA (US)

(72) Inventors: Raymond F. Wong, Chino Hills, CA (US); Jason Tabb, Orange, CA (US); Aaron Goodall, Orange, CA (US); Stanley S. Huang, Irvine, CA (US); Albert Ruiz-Vela, Alta Loma, CA (US)

(21) Appl. No.: 14/327,077

(22) Filed: Jul. 9, 2014

Related U.S. Application Data
(60) Provisional application No. 61/846,549, filed on Jul. 15, 2013.
(60) Provisional application No. 61/846,367, filed on Jul. 15, 2013.

(51) Int. Cl. A61C 7/14; A61C 7/16

(52) U.S. Cl. CPC A61C 7/146; A61C 7/16
USPC 433/9; 433/24; 156/311

(57) ABSTRACT

An adjustable orthodontic bracket is described which includes a body member having an orthodontic archwire fixing member and a first faying surface; a bonding base member having a second faying surface and a tooth bonding surface; and a connecting member that includes a layer of a thermoplastic polymer, and which connects the first faying surface of the body member to the second faying surface of the bonding base member. Methods of repositioning and manufacturing the adjustable orthodontic brackets are also described. A method is also provided for reducing a bond strength of an orthodontic appliance adhered to a tooth structure with a cured adhesive composition, which includes treating the orthodontic bracket with ultrasonic energy thereby reducing the bond strength more than about 20%. The cured adhesive composition includes an ultrasonic energy responsive filler, and under the ultrasonic energy stimulation, the cured adhesive composition softens thereby reducing the overall bonding strength.

### CROSS-REFERENCE TO RELATED APPLICATIONS

This application claims the benefit of U.S. Provisional Application Ser. No. 61/846,549 filed Jul. 15, 2013 and U.S. Provisional Application Ser. No. 61/846,367 filed Jul. 15, 2013, the disclosures of which are incorporated by reference herein in their entirety.

### FIELD OF THE INVENTION

This disclosure pertains to orthodontic brackets, and more specifically to adjustable orthodontic brackets and methods of debonding orthodontic brackets using ultrasonic methods.

### BACKGROUND

Orthodontics is the study of dentistry that is concerned with the treatment of improper bites, and crooked teeth. Orthodontic treatment can facilitate movement of a patient's teeth to the desired alignment. Orthodontists usually use braces and effect the repositioning of the patient's teeth. Tiny orthodontic appliances known as brackets are bonded or connected to exterior surfaces of the patient's teeth, and an archwire is placed in a slot of each bracket. The archwire forms a track to guide movement of the teeth to desired positions for correct occlusion. In recent years it has become common practice to use adhesives to bond orthodontic appliances to the surface of the tooth, using either direct or indirect methods. A variety of adhesives are available to the practitioner for bonding brackets to tooth surfaces, and many offer excellent bond strengths. High bond strengths are desirable for maintaining adhesion of the bracket to the tooth surface over the duration of the treatment process, which can typically be two years or more.

However, orthodontic adhesives with high bond strengths can lead to other difficulties. For example, one of the more difficult aspects of the orthodontic treatment process can be the removal of the bracket after completion of treatment. It is well known in the industry that certain adhesives, used in combination with certain rigid brackets, are capable of causing enamel fracture under some debonding conditions. Additionally, the excessive debonding force can be painful for the patient and discomforting for the clinician.

As a result of these issues, one recently proposed solution disclosed in U.S. Patent Application Publication No. 2007/0142498 is the incorporation of a thermally responsive additive, and optionally a radiation-to-heat converter, to the bonding composition. Accordingly, upon application of a sufficient amount of heat or radiation, the thermally responsive additive melts or softens thereby reducing the bonding strength of the bonding composition. However, the disclosed heating methods, such as heating with lasers, warm water, electrothermal debonding units, or a heated gel tray, as well as by exposure to radiation that is absorbed by the radiation-to-heat converter, may cause irreparable damage to the tooth by concomitant heating of the underlying nerve tissue.

Additionally, bracket placement has always been important in orthodontics, insofar as tooth positioning is extremely dependent upon ideal bracket positioning. Since bracket position directly affects the force application of the archwire and ultimately the final position of the tooth, correct initial placement, as well as the alignment of the brackets during treatment, is important. Positioning instruments have been devised, and most recently, computer aided indirect bonding has been devised which attempts to predict the final tooth position based on a recommended bracket position.

Nevertheless, even using the newest and most advanced types of orthodontic brackets, patients still require a follow-up appointment, which is generally scheduled about 6 months after the initial application of the brackets, to refine the position of the brackets. This appointment is focused on repositioning the brackets using a panorex X-ray and marginal ridge heights to improve bracket position. This “pano-repo” visit is done on all patients and may be necessary more than once during their treatment thereby requiring multiple visits to the orthodontist.

Specifically, a patient is reappointed in 6-8 weeks for a 45 minute appointment. During this visit, an average of 4-6 brackets are removed and discarded. The bonding adhesive or cement is cleaned off the tooth; the teeth are then etched, sealed, re-bracketed with new brackets; and the archwire reconnected. This is a very time consuming process, with the added risk of enamel fracture during the bracket debonding step. In short, it would be advantageous if orthodontic brackets could be bonded only once, at the beginning of treatment, and adjustable thereafter.

Accordingly, new methods are needed that offer satisfactory adhesion of the bracket to the tooth surface throughout the treatment process, and also allow for more convenient and safer removal upon completion of the treatment. Additionally, new methods and orthodontic brackets are needed that enable the repositioning of the body member without the need to remove the bonding base member from the tooth structure.

### SUMMARY OF THE INVENTION

In one aspect, embodiments of the present invention provide an adjustable orthodontic bracket, which permits repositioning without the need to remove and replace the entire orthodontic bracket. The adjustable orthodontic bracket comprises a body member comprising an orthodontic archwire fixing member for fixing one or more orthodontic archwires in a position such that a predetermined stress is generated and applied to a tooth to be treated, and a first faying surface; a bonding base member for bonding the adjustable orthodontic bracket to a buccal or lingual side of the tooth to be treated, comprising a second faying surface and a tooth bonding surface; and a connecting member comprising a layer of a thermoplastic polymer, which connects the first faying surface of the body member to the second faying surface of the bonding base member.

In a second aspect, embodiments of the present invention provide a method of repositioning the adjustable orthodontic bracket, which includes a body member, a bonding base member, and a connecting member comprising a layer of a thermoplastic polymer that connects the body member to the bonding base member. The method comprises engaging the body member with a working end of an ultrasonic energy device; supplying ultrasonic energy to the body member that passes through the body member to the connecting member comprising the layer of the thermoplastic polymer, thereby increasing a temperature of the thermoplastic polymer above a softening temperature; repositioning the body member relative to a stationary bonding base member adhered to a surface of a tooth structure; and terminating the transmission of ultrasonic energy thereby allowing the temperature of the thermoplastic polymer to decrease below the softening temperature.

In a third aspect, embodiments of the present invention provide a method of manufacturing an adjustable orthodontic bracket comprising a body member, a bonding base member, and a connecting member. The method comprises pre-assembling the adjustable orthodontic bracket by positioning the connecting member between a first faying surface of the body member and a second faying surface of the bonding base member, wherein the connecting member comprises a thermoplastic polymer to provide a pre-assembled bracket; heating the pre-assembled bracket to increase a temperature of the thermoplastic polymer to a value at or above which the polymer melts; and lowering the temperature of the thermoplastic polymer to a value at or below which the polymer solidifies.

In a fourth aspect, embodiments of the present invention provide a method for reducing the bond strength of an orthodontic appliance adhered to a tooth structure with a cured adhesive composition (e.g., a cured orthodontic adhesive, a cured orthodontic cement, and/or a cured orthodontic primer) that includes an ultrasonic energy responsive filler.

In a fifth aspect, embodiments of the present invention provide a method for reducing a bond strength of an orthodontic appliance adhered to a tooth structure with a cured adhesive composition, where the method comprises treating the orthodontic bracket with ultrasonic energy thereby reducing the bond strength more than about 20%. Under the ultrasonic energy stimulation, the ultrasonic energy responsive filler in the cured adhesive composition softens thereby reducing the overall bonding strength, which allows for convenient removal of the orthodontic appliance from the tooth structure (e.g., less force required to debond the orthodontic appliance). In some embodiments, the ultrasonic energy responsive filler and/or dental composition including the same, can be placed so as to result in fracture (e.g., adhesive failure) upon debonding at an interface (e.g., an adhesive-tooth interface or an appliance-adhesive interface), or cohesive failure within the cured adhesive composition upon debonding. For example, fracture at an adhesive-tooth interface can result in the cured adhesive being substantially retained on the tooth structure, thereby virtually eliminating any risk for enamel fracture.

### BRIEF DESCRIPTION OF THE DRAWINGS

An embodiment of the adjustable orthodontic bracket is described below with reference to the following accompanying drawings, in which:

FIG. 1 is a front perspective, elevation view of an adjustable orthodontic bracket, in accordance with an embodiment of the present invention, shown bonded to a tooth structure;

FIG. 2 is a cross-sectional view taken along the line 2-2 of FIG. 1;

FIG. 3 is a front perspective, exploded, elevation view of an adjustable orthodontic bracket, in accordance with an embodiment of the present invention;

FIG. 4 is a front perspective, elevational view of an adjustable orthodontic bracket, in accordance with another embodiment of the present invention;

FIG. 5A is a front perspective, elevational view of the adjustable orthodontic orthodontic bracket shown in FIG. 4, shown in a first position; and

FIG. 5B is a front perspective, elevational view of the adjustable orthodontic bracket shown in FIG. 4, shown in second position after ultrasonic stimulation and repositioning, in accordance with an embodiment of the present invention.

### DETAILED DESCRIPTION

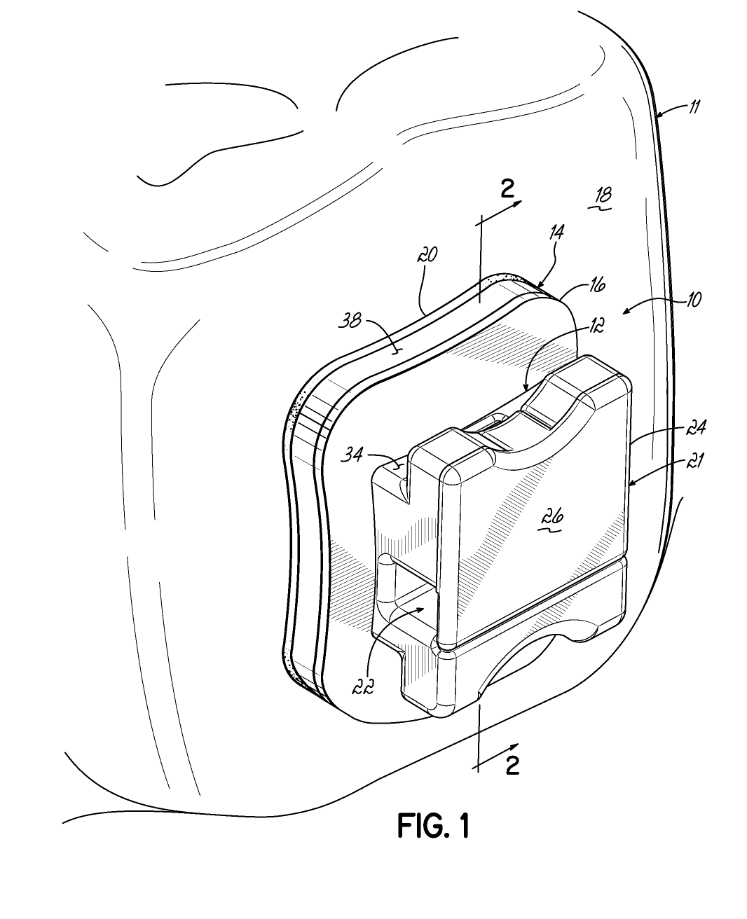

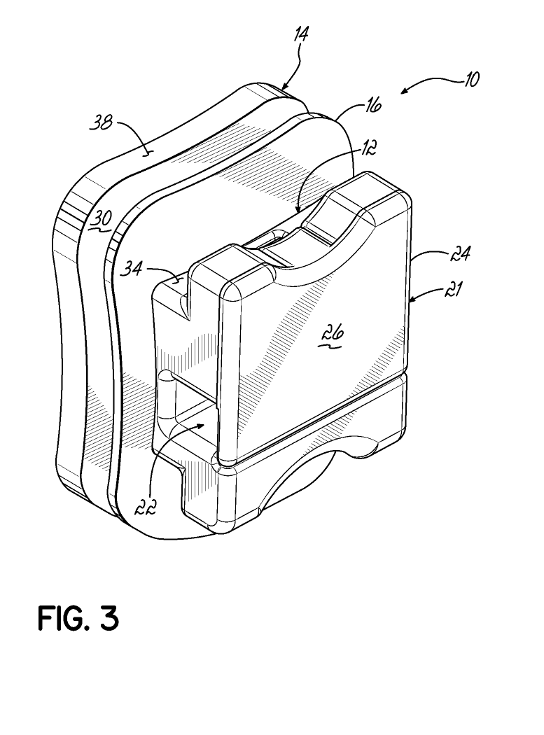

In reference to FIGS. 1-3, an exemplary adjustable orthodontic bracket, hereinafter referred to as “bracket,” of the present invention is generally indicated by the numeral 10 therein. The illustrated details of the bracket 10 of the present invention may be used in many different combinations within the scope of this disclosure. For this reason, the details of the bracket, as described hereinafter, are intended to be merely illustrative, and are not restrictive of the embodiments of the present invention. When referring to the illustrated form of the bracket 10, and its component parts, the front surfaces, that is, directed outwardly from a supporting tooth shall be referred to as the labial surface. Conversely, its rear surfaces, that is, those facing toward the tooth shall be termed the lingual surfaces. Directions along a bracket 10 generally parallel to the incisal or occlusal line or plane shall be referred to as having width and/or being transverse to the incisal or occlusal line. Conversely, perpendicular directions extending in generally upright orientations between the gingival line, and the incisal, or occlusal line shall be referred to as the height of the bracket assembly. The upright side surfaces across the bracket 10 shall be termed its mesial and distal surfaces, and surfaces along the top and bottom of the bracket assembly shall be termed the incisal or occlusal (or superior) surfaces and the gingival (or inferior) surfaces, respectively.

The archwire slots shown in the attached drawings are aligned transversely across each bracket in a direction that is approximately parallel to the incisal and/or occlusal surfaces for general illustration purposes, only. However, the archwire slot across each bracket can be oriented in any desired angular configuration relative to: 1) its incisal or occlusal surfaces to affect a desired degree of tipping to a supporting tooth, 2) its labio-lingual or bucco-lingual inclination of the long axis of the tooth's crown to affect a desired degree of torque, or 3) the mesial or distal rotational variation off the desired dental arch. In addition, the bracket 10 can be oriented angularly relative to a supporting pad thereby providing an angular force to the archwire slot, and engaged archwire, when secured to a supporting tooth.

In order to properly fit upon the exterior surface of a selected tooth structure, the posterior surface across the pad (or bonding base member) for each bracket 10, must be molded or otherwise formed to conform to the tooth. However, in accordance with principles of the present invention, the archwire slot can be adjusted to the desired angular relationship to the archwire after installation. Accordingly, various placement angles can be provided on a single bracket after the bracket is bonded to the tooth structure. The illustrative bracket 10, as shown herein, is designed to be bonded directly to a tooth at either the facial or lingual tooth surfaces.

The bracket 10 can be made from any suitable material including metals, ceramics, plastics, as well as a combination of such materials, as discussed in more detail below. Many of the components of the bracket 10, as shown herein, are typically fabricated out of metal, but the choice of materials is not critical to the understanding or the subsequent clinical use of the invention. The only limitations with regard to the chosen materials are the ability to efficiently fabricate the bracket 10, and its ultrasonic transmission properties with respect to ultrasonic energy.

The bracket 10 finds usefulness when used in an orthodontic procedure, which affects a plurality of teeth within a patient's mouth. Nevertheless, for the purpose of describing the embodiments of the present invention, only one tooth structure 11 is shown in each of the FIGS. 1-3. In reference to FIG. 1, the bracket 10 includes a body member 12, a bonding base member 14, and a connecting member 16. The bracket 10 is bonded to an exterior facing surface 18 of the tooth structure 11, where the bonding base member 14 is typically affixed with a layer of an adhesive 20.

With reference to FIG. 1, the body member 12 includes an orthodontic archwire fixing member 21 having a substantially transversely disposed archwire slot 22, which extends thereacross, and which is further operable to receive a suitable archwire (not shown) therein. A ligating gate 24, which is movable to allow access to the archwire slot 22 during placement of the archwire and restricts access to the archwire slot 22 when closed.

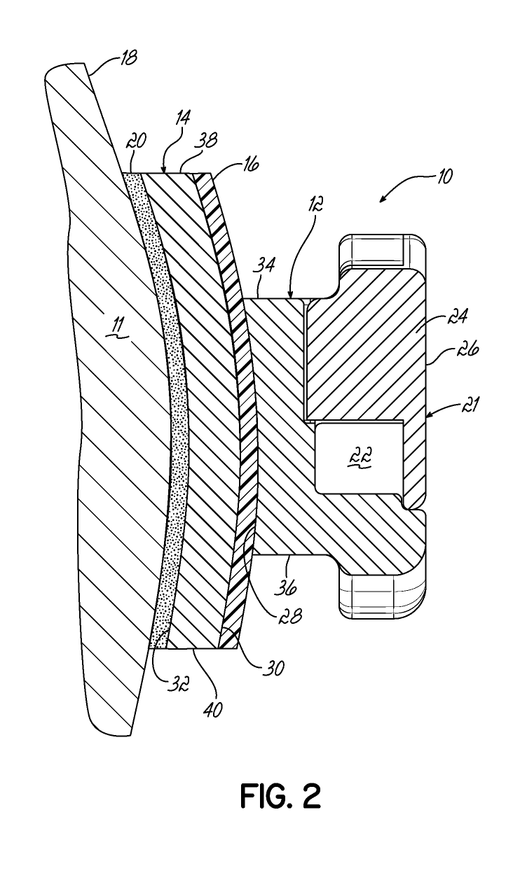

Referring now to FIG. 2, the body member 12 has an anterior-facing surface 26 and a posterior-facing faying surface 28. Conversely, the bonding base member 14 has an anterior-facing faying surface 30 and a posterior facing tooth bonding surface 32, which is adhesively affixed to the exterior surface 18 of the tooth structure 11 of a patient. The body member 12 further has a top, or superior surface 34, and an opposite, lower, or inferior surface 36. The bonding base member 14 has a superior edge 38 and an inferior edge 40. Positioned between the body member 12 and the bonding base member 14 is the connecting member 16. The connecting member 16 serves to structurally bond the posterior-facing faying surface 28 of the body member 12 to the anterior-facing faying surface 30 of the bonding base member 14, yet permits relative movement when sufficiently stimulated with ultrasonic energy.

Thus, in accordance with embodiments of the present invention, the connecting member 16 comprises a thermoplastic polymer, which softens when treated with ultrasonic energy of a sufficient magnitude and duration. As used herein, “softening” refers to loss of modulus of a material that can occur as a result of physical and/or chemical changes in the material. It should be appreciated that ultrasonic energy is a form of mechanical energy that can be transferred from an ultrasonic device by direct physical contact with the thermoplastic polymer, or by indirect contact through adjacent structures, such as the body member 12 or the bonding base member 14. This transfer of mechanical energy thereby imparts kinetic energy, which, in effect, heats the thermoplastic polymer to its softening point. Softening of the thermoplastic polymer permits repositioning of body member 12 relative to a stationary bonding base member 14, which is adhered to the exterior-facing tooth surface 18, without having to completely melt the connecting member 16. While connecting member 16 is depicted as a layer having a generally uniform thickness, it should be appreciate that variable thicknesses may also be used. Variation in thickness of connecting member 16 could provide the ability to tune or modify the tipping, torque, or rotational forces applied to the exterior-facing tooth surface 18 of the tooth 11.

Thus, according to one embodiment of the present invention, the softening point of the thermoplastic polymer occurs at a temperature of about 165° F. (about 74° C.) or less. For example, the softening point of the thermoplastic polymer can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.). In one embodiment, the softening temperature is greater than about 120° F. (about 49° C.).

Two important considerations regarding the softening point of the thermoplastic polymer are pulp necrosis and unintentional mobility. If the softening point is too high, there is a potential that the elevated temperature to achieve repositioning of the body member 12 can overheat the underlying dental tissue and cause tissue death. On the other hand, if the softening point of the thermoplastic polymer is too low, hot liquids such as hot coffee could unintentionally weaken the connecting member 16 and permit relative movement between the body member 12 and the bonding base member 14. The foregoing temperature ranges for the preferred softening point of the thermoplastic polymer balance these two important considerations.

Depending on the physical identity of the material, heat distortion temperature (HDT), melt transition temperature (Tm), or glass transition tempertature (Tg) can be used herein as benchmarks for characterizing the softening point of the thermoplastic polymer. More precisely, the HDT is the temperature at which the thermoplastic polymer will deform under a specified load. The HDT is determined by the following test procedure outlined in ASTM D648. The test specimen is loaded in three-point bending in the edgewise direction. The load stress used for testing for purposes of this invention is 1.82 MPa, and the temperature is increased at 2° C./min until the thermoplastic polymer specimen deflects 0.25 mm. Tm and Tg can be determined by following the test procedures outlined in ASTM D3418 and ASTM E1640, respectively. Accordingly, the softening point may be expressed as the HDT, Tm, or Tg of the thermoplastic polymer, as applicable.

Thermoplastic polymers having a wide variety of morphologies can be used. For example, the connecting member 16 may comprise a semicrystalline thermoplastic polymer, an amorphous thermoplastic polymer, or a combination thereof. According to one aspect, the thermoplastic polymers may be opaque or colorless, which can be aesthetically pleasing to the patient.

It should be appreciated that within a given polymer type, there could be enough molecular weight variation to cause the Tg range to be excessively broad. Thus, a narrow distribution MW with a minimally acceptable Tg would be advantageous. In accordance with one embodiment, a polymer with a narrow molecular weight distribution, which would exhibit a sharp transition melting and thereby minimize excessive ultrasonic heat, is used as the thermoplastic polymer of the connecting member 16. The ratio of the weight-average molecular weight (M_{w}) and number-average molecular weight (Mₙ), M_{w}/Mₙ, is a measure of the polydispersity of a polymer mixture, i.e., how widely distributed the range of molecular weights are in the mixture. A ratio that is around 1.0 indicates that the range of molecular weights in the mixture is narrow; a high ratio indicates that the range is wide. According to one embodiment, the ratio is less than about 1.5, for example, about 1.4 or less, about 1.3 or less, about 1.2 or less, or about 1.1 or less.

Examples of polymer classes that can be used for the connecting member 16 include poly((meth)acrylics), poly((meth)acrylamides), poly(alkenes), poly(dienes), poly(styrenes), polyvinyl alcohol), polyvinyl ketones), polyvinyl esters), polyvinyl ethers), polyvinyl thioethers), polyvinyl halides), polyvinyl nitriles), poly(phenylenes), poly(anhydrides), poly(carbonates), poly(esters), poly(lactones), poly(ether ketones), poly(alkylene oxides), poly(urethanes), poly(siloxanes), poly(sulfides), poly(sulfones), poly(sulfonamides), poly(thioesters), poly(amides), poly(anilines), poly(imides), poly(imines), poly(ureas), poly(phosphazenes), poly(silanes), poly(silazanes), carbohydrates, gelatins, poly(acetals), poly(benzoxazoles), poly(carboranes), poly(oxadiazoles), poly(piperazines), poly(piperidines), poly(pyrazoles), poly(pyridines), poly(pyrrolidines), poly(triazines), and combinations thereof. In one embodiment, the connecting member 16 comprises a methyl methacrylate-based copolymer, such as a methyl methacrylate-hydroxyethylmethacrylate copolymer.

The body member 12 and the bonding base member 14 may be constructed of conventional materials, such as metal, ceramic, plastic, or combinations thereof. However, if plastic is used, the softening point of the chosen plastic should be substantially higher than the softening point of the thermoplastic polymer of the connecting member 16. For example, the softening point should be greater than about 100° C. (about 212° F.).

Another aspect of the materials chosen for the body member 12 and the bonding base member 14 is its ultrasonic transmission properties. In accordance with one embodiment, it would be advantageous to construct the body member 12 from a material with high ultrasonic energy transmission property, while the bonding base member 14 is constructed of a material having a low ultrasonic energy transmission property. This arrangement could facilitate rapid/efficient transfer of the ultrasonic energy from the ultrasonic device through the body member 12 to the connecting member 16, but minimize the continued transmission of the ultrasonic energy through the connecting member 16 and the bonding base member 14 to the tooth pulp.

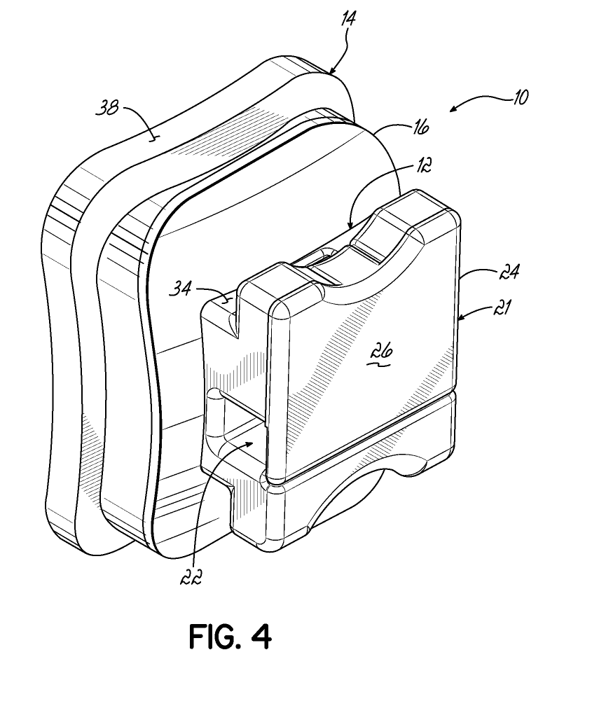

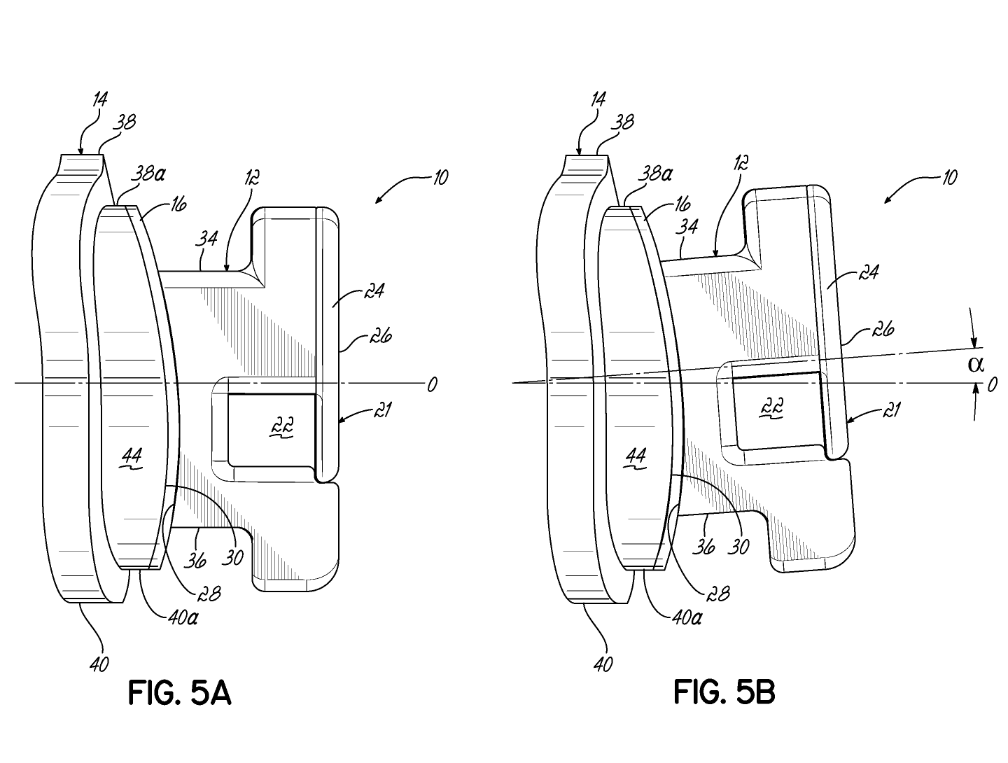

In reference to FIGS. 4 and 5A-B, in accordance with another embodiment of the present invention, the bonding base member 14 further comprises a variable thickness portion 44. As shown in FIG. 4, the anterior-facing faying surface 30 of the variable thickness portion 44 of the bonding base member 14 may have a generally uniform convex configuration, which comprises a continuous layer of the connecting member 16 thereon. The posterior-facing faying surface 28 of the body member 12 can be adapted to generally conform to the anterior-facing faying surface 30. While the embodiment in FIG. 4 shows the variation in the variable thickness portion 44 of the bonding base member 14 extending from inferior edge 40 to the superior edge 38, it should be appreciated that thickness variations can also be provided in the mesial-distal directions. According to one embodiment, the variable thickness portion 44 may comprise a constant radial change curvature. In another embodiment, the variable thickness portion 44 comprises a non-constant radial change curvature.

To facilitate a sufficiently strong physical connection between the body member 12 and the bonding base member 14, the posterior-facing faying surface 28 and the anterior-facing faying surface 30 can be designed for high strength adhesion to provide at least about 10 MPa, and more preferably at least about 20 MPa, of shear bond strength (SBS). Accordingly, one or both of the faying surfaces 28, 30 can include a laser etched portion. Metal Injection Molding (MIM) and Ceramic Injection Molding (CIM) and laser etching of green bodies from MIM and CIM is more completely described in commonly-owned U.S. Patent Application Publication Nos. 2006/0166158 and 2012/0058442, each of which is incorporated herein by reference in its entirety. In one embodiment, the laser etched portion includes laser-generated cross-hatching or a bull's eye. In another embodiment, the laser etched portion includes parallel lines. In yet another embodiment, the laser etched portion includes a pre-determined pattern, such as a design, a trademark to be viewed by the dental practitioner prior to tooth attachment, or other more functional pattern. In each case, the laser etched portion can include from about 0.01 to about 10 mm of laser etched lines (including curved or straight lines). In another aspect, the laser etched portion can include from about 0.01 to about 5 mm of laser etched lines. In another aspect, the laser etched portion can include from about 0.02 to about 2 mm of laser etched lines. In yet another aspect, the laser etched portion can include from about 0.1 to about 1 mm of laser etched lines. Furthermore, the depth of the laser etched lines can also be kept within a desired range to provide an appropriate average bonding strength. For example, typical laser etched line depths may be from about 0.01 mm to about 1 mm, though depths from about 0.05 mm to about 0.3 mm may be more typical. These ranges of laser etched lines are not meant to be limiting, but rather describe exemplary ranges of lines that can be used.

In another embodiment, to facilitate a sufficiently strong physical connection between the body member 12 and the bonding base member 14, the posterior-facing faying surface 28, the anterior-facing faying surface 30, or both can be designed with a mesh portion (not shown).

The posterior-facing tooth bonding surface 32 of the bonding base member 14 can be similarly modified with a laser etched portion or a mesh portion to provide an increased and more predictable adhesive bonding strength.

The foregoing faying surface modifications (i.e., laser etched or mesh), which can improve the bonding strength between the faying surfaces 28, 30 of the body member 12 and the bonding base member 14, provide a relatively tortuous morphology of micro undercuts and voids in which a molten thermoplastic polymer can flow and solidify upon cooling. To that end, in accordance with another embodiment, a method of manufacturing the adjustable orthodontic bracket 10 is provided. The manufacturing method comprises pre-assembling the components of the bracket 10 by positioning a layer of a thermoplastic polymer, which serves as the connecting member 16, between the faying surfaces 28, 30 of the body member 12 and the bonding base member 14, respectively. In one embodiment, the connecting member 16 completely covers the anterior-facing faying surface 30 of the bonding base member 14, so that thermoplastic polymer is present across the entire area during repositioning. The resulting pre-assembly is then heated to increase the temperature of the thermoplastic polymer to a value at or above which the polymer becomes flowable (i.e., melts), which permits the molten thermoplastic polymer to flow into the micro undercuts and voids. The temperature of the thermoplastic polymer is then decreased to a value at or below which the polymer solidifies.

The bracket 10 formed by the described process can be bonded to a tooth 11 and repositioned by stimulating the connecting member 16 with ultrasonic energy, as described next.

The bracket 10 may be bonded to the exterior-facing surface 18 of the tooth 11 with any suitable adhesive. A layer of an adhesive 20 (prior applied or newly applied) covers the entire posterior facing tooth bonding surface 32 of the bonding base member 14 so as to provide exudate along the entire perimeter, i.e., including the superior, inferior, mesial, and distal edges, of member 14. This will guard against micro-leakage, which could lead to adverse enamel conditions including staining, decalcification, and permanent tooth damage. The adhesive coated bracket is then positioned at its desired location on the exterior-facing surface 18 of the tooth 11. After curing to achieve the desired bonding strength, the bracket 10 is capable of being repositioned without any debonding between the tooth 11 and the bonding base member 14.

In accordance with another embodiment of the present invention, a method of repositioning the bracket 12 is provided. The method includes engaging the body member 12 with a working end of an ultrasonic energy device; supplying ultrasonic energy to the body member 12 that passes through the body member 12 to the connecting member 16 comprising the layer of the thermoplastic polymer, thereby increasing a temperature of the thermoplastic polymer above a softening temperature; force is applied to the body member 12 to effect repositioning of the body member 12 relative to the stationary bonding base member 14 adhered to the exterior-facing surface 18 of the tooth 11. The repositioning method further includes terminating the transmission of ultrasonic energy thereby allowing the temperature of the thermoplastic polymer to decrease below the softening temperature.

As shown in FIGS. 5A-5B, in one embodiment the bracket 10 may be repositioned to provide a tipping angle (α) by repositioning the bracket 10 in the occlusal or incisal direction. In particular, the body member 12 having been previously attached to the tooth surface may be reoriented by application of ultrasonic energy to the bracket 10 and then shifting the body member 12 relative to the bonding base member 14. The relative shapes of one or more of the body member 12, the variable thickness portion 44, and the bonding base member 14 being configured to allow an angular orientation, such as the tipping angle (α), of the archwire slot 22 relative to the tooth surface to be changed without debonding the bracket 10 from the tooth surface. It should be appreciated that torque and rotational forces may be similarly provided depending on the directional and degree of variation in the variable thickness portion 44 of the base bonding member 14.

The ultrasonic device can be equipped with a linear oscillator and a tip assembly configured to engage or clasp the body member 12 of the bracket 10. One exemplary ultrasonic device is Kayo Piezito ultrasonic unit (Kayo, Federal Republic of Germany), which operates at maximum power of 10 watts over a frequency range of about 25 kHz to about 35 kHz. In one embodiment, a DeProxi tip was used with the Piezito ultrasonic unit to provide ultrasonic stimulation to the bracket 10. The ultrasonic stimulation to the bracket 10 is maintained for a time sufficient to result in an increase in the temperature of the thermoplastic polymer of the connecting member 16 or variable thickness portion 44 to its softening point. According to one embodiment, the ultrasonic energy may be supplied to the body member 12 for between about 1 second to about 30 seconds.

In accordance with another embodiment of the present invention, a method for reducing a bond strength of an orthodontic appliance adhered to a tooth structure with a cured adhesive composition is provided. The method comprises treating the orthodontic bracket with ultrasonic energy thereby reducing the bond strength more than about 20%. Under the ultrasonic energy stimulation, the ultrasonic energy responsive filler in the cured adhesive composition softens thereby reducing the overall bonding strength, which allows for convenient removal of the orthodontic appliance from the tooth structure (e.g., less force required to debond the orthodontic appliance).

As further used herein, “adhesive composition” refers to a material (e.g., a dental or orthodontic material) capable of adhering (e.g., bonding) to a tooth structure. Adhesive compositions include, for example, adhesives (e.g., dental and/or orthodontic adhesives), cements (e.g., glass ionomer cements, resin-modified glass ionomer cements, and/or orthodontic cements), primers (e.g., orthodontic primers), restoratives, liners, sealants (e.g., orthodontic sealants), and coatings.

As used herein, “orthodontic appliance” refers to any device intended to be bonded to a tooth structure, including, but not limited to, orthodontic brackets, buccal tubes, lingual retainers, orthodontic bands, bite openers, buttons, and cleats. The appliance has a base for receiving adhesive and it can be made of metal, plastic, ceramic, or combinations thereof. Alternatively, the base can be a custom base formed from cured adhesive layer(s) (i.e., single or multi-layer adhesives).

As used herein, an “ultrasonic energy responsive filler” refers to a filler that softens upon treatment with ultrasonic energy.

As used herein with respect to the adhesive composition, “softening” refers to loss of modulus of a material that can occur as a result of physical and/or chemical changes in the material. Depending on the physical identity of the material, heat distortion temperature (HDT), melt transition temperature (Tm), or glass transition temperature (Tg) can be used herein as a benchmark for characterizing the softening of the ultrasonic energy responsive filler. More precisely, the HDT of the ultrasonic energy responsive filler is the temperature at which the ultrasonic energy responsive filler sample deforms under a specified load. The HDT is determined by the following test procedure outlined in ASTM D648. The test specimen is loaded in three-point bending in the edgewise direction. The outer fiber stress used for testing for purposes of this invention is 1.82 MPa, and the temperature is increased at 2° C./min until the specimen deflects 0.25 mm. Tm and Tg are determined by following the test procedures outlined in ASTM D3418 and ASTM E1640, respectively.

As used herein, “tooth structure” refers to surfaces including, for example, natural and artificial tooth surfaces, bone, tooth models, and the like.

As used herein, a “multi-layer” adhesive refers to an adhesive having two or more distinctly different layers (i.e., layers differing in composition, and may have different chemical and/or physical properties).

As used herein, a “layer” refers to a discontinuous (e.g., a patterned layer) or continuous (e.g., non-patterned) material extending across all or a portion of a material different than the layer. The layer may be of uniform or varying thickness.

As used herein, a “patterned layer” refers to a discontinuous material extending across (and optionally attached to) only selected portions of a material different than the patterned layer.

As used herein, a “non-patterned layer” refers to a continuous material extending across (and optionally attached to) an entire portion of a material different than the non-patterned layer.

In general, a layer “on,” “extending across,” or “attached to” another material different than the layer is intended to be broadly interpreted to optionally include one or more additional layers between the layer and the material different than the layer.

As used herein, “cured” is descriptive of a material or composition that can be solidified, for example, by polymerizing or by ionic or covalent crosslinking. Exemplary methods of curing include heating to induce polymerization and/or crosslinking; irradiating to induce polymerization and/or crosslinking; and/or by mixing one or more components to induce polymerization and/or crosslinking. “Mixing” can be performed, for example, by combining two or more parts and mixing to form a homogeneous composition. Alternatively, two or more parts can be provided as separate layers that intermix (e.g., spontaneously or upon application of shear stress) at the interface to initiate polymerization. Another common method for solidifying the material may include removing solvent (e.g., by evaporation and/or heating).

As used herein, the term “methacrylate” includes (meth)acrylate, acrylate, or combinations thereof, and “methacrylic” includes (meth)acrylic, acrylic, or combinations thereof.

Embodiments of the present invention provide a method for reducing a bond strength of an orthodontic appliance adhered to a tooth structure with a cured adhesive composition, where the method comprises treating the orthodontic bracket with ultrasonic energy thereby reducing the bond strength more than about 20%. Under the ultrasonic energy stimulation, the ultrasonic energy responsive filler in the cured adhesive composition softens thereby reducing the overall bonding strength, which allows for convenient removal of the orthodontic appliance from the tooth structure (e.g., less force required to debond the orthodontic appliance). Thus, according to one aspect of the invention, curable and cured adhesive compositions of the present invention include thermally responsive additives, which are described in detail herein.

The ultrasonic energy responsive filler can be incorporated into a wide variety of curable adhesive compositions (e.g., dental and orthodontic materials) at levels effective to decrease bond strength of the cured composition upon ultrasonic stimulation, while maintaining sufficient adhesion (e.g., of an orthodontic appliance) to the tooth structure during treatment. Treatment can include dental and/or orthodontic treatment processes that last a month, a year, two years, or even longer.

For certain embodiments, such adhesive compositions can be conveniently applied to the base of an orthodontic appliance by a practitioner. Alternatively, orthodontic appliances can be provided having such adhesive compositions precoated on the base of the appliance.

Curable adhesive compositions of the present invention include a polymerizable monomer, a curing initiator, and a filler component comprising the ultrasonic energy responsive filler. In some embodiments, the filler component further includes an inorganic filler, a composite filler, or combinations thereof. Such curable adhesive compositions, upon curing, can bond an orthodontic appliance to a tooth structure with a bond strength (using the debonding test method described herein) of at least 7 MPa at room temperature.

Ultrasonic Energy Responsive Fillers

Curable and cured dental compositions of the present invention include the ultrasonic energy responsive filler. Specifically, upon ultrasonic stimulation of the ultrasonic energy responsive filler with ultrasonic energy by linear oscillation at a frequency in the range of about 25 to about 35 kHz, the filler softens. One useful source for ultrasonic energy is KaVo PiezoLED device. It should be appreciated that ultrasonic energy is a form of mechanical energy that can be transferred from an ultrasonic device by direct physical contact with the ultrasonic energy responsive filler, or by indirect contact through the orthodontic appliance, the cured adhesive matrix, or a combination thereof. This transfer of mechanical energy thereby imparts kinetic energy, which, in effect, heats the ultrasonic energy responsive filler. Thus, according to one aspect of embodiments of the present invention, the ultrasonic energy responsive filler may have a heat distortion temperature (HDT) of about 165° F. (about 74° C.) or less. For example, the HDT of the ultrasonic energy responsive filler can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.). Depending on the type of material making up the ultrasonic energy responsive filler, the ultrasonic energy responsive filler may be similarly characterized by its melt transition temperature (Tm) or its glass transition temperature (Tg), as discussed below.

Accordingly, upon ultrasonic stimulation, which concomitantly elevates the temperature of the cured dental composition, the bond strength of the cured adhesive composition decreases compared to the bond strength of the cured adhesive composition in the absence of ultrasonic energy stimulation. Thus, in accordance with embodiments of the present invention, the bond strength of the cured adhesive composition under the ultrasonic stimulation conditions is at most 90%, more preferably at most 80%, 50%, 30%, 20%, or even 10% of the bond strength of the cured adhesive composition in the absence of ultrasonic energy stimulation. Further, in certain embodiments, it is preferred that bond strengths at an elevated temperature be maintained at a sufficient level (e.g., to avoid having brackets falling off into the patient's mouth before pressure is applied by the practitioner). In such embodiments, it is preferred that the bond strength of the cured adhesive composition at the elevated temperature (e.g., upon exposure to hot foods) is at least 5 MPa at the elevated temperature.

Adhesive compositions including at most 50 wt % (e.g., at most 40 wt %, 30 wt %, 20 wt %, 10 wt %, 5 wt %, or even 1 wt %) loading of the ultrasonic energy responsive filler can exhibit such losses in storage modulus and/or bond strength at an elevated temperature. Further, at the same loadings of ultrasonic energy responsive filler, the bond strength of the cured adhesive composition at room temperature (e.g., 25° C.) is at least 50%, (e.g., at least 70%, 90%, 100%, or even greater than 100%) of the bond strength of the cured adhesive composition in the absence of ultrasonic energy stimulation.

In some embodiments, ultrasonic energy responsive fillers can be polymers. Polymers having a wide variety of morphologies can be used. For example, the ultrasonic energy responsive filler can be a semicrystalline polymer, an amorphous polymer, or a combination thereof. In some embodiments, ultrasonic energy responsive fillers can be liquid crystals (e.g., non-polymeric liquid crystals or polymeric liquid crystals). In some embodiments, ultrasonic energy responsive fillers can be waxes.

Useful semicrystalline polymers typically have a melt transition temperature (Tm) of about 165° F. (about 74° C.) or less. For example, the melt transition temperature (Tm) of the semicrystalline polymers can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.).

Useful amorphous polymers typically have a glass transition temperature (Tg) of about 165° F. (about 74° C.) or less. For example, the glass transition temperature (Tg) of the amorphous polymers can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.).

Examples of polymer classes that can be used for ultrasonic energy responsive fillers include poly((meth)acrylics), poly((meth)acrylamides), poly(alkenes), poly(dienes), poly(styrenes), poly(vinyl alcohol), poly(vinyl ketones), poly(vinyl esters), poly(vinyl ethers), poly(vinyl thioethers), poly(vinyl halides), poly(vinyl nitriles), poly(phenylenes), poly(anhydrides), poly(carbonates), poly(esters), poly(lactones), poly(ether ketones), poly(alkylene oxides), poly(urethanes), poly(siloxanes), poly(sulfides), poly(sulfones), poly(sulfonamides), poly(thioesters), poly(amides), poly(anilines), poly(imides), poly(imines), poly(ureas), poly(phosphazenes), poly(silanes), poly(silazanes), carbohydrates, gelatins, poly(acetals), poly(benzoxazoles), poly(carboranes), poly(oxadiazoles), poly(piperazines), poly(piperidines), poly(pyrazoles), poly(pyridines), poly(pyrrolidines), poly(triazines), and combinations thereof. One of skill in the art could select, without undue experimentation, polymers from the above-recited classes that have desired HDT or transition temperatures. See, for example, “Polymer Handbook,” 4th Edition edited by J. Brandrup et al. (1999) for a list of HDTs, melt transition temperatures, and glass transition temperatures of selected polymers.

A wide variety of liquid crystals can be used for ultrasonic energy responsive fillers including, for example, those recited in “Liquid Crystals Handbook,” volumes 1-3, edited by Demus et al. (1998). Suitable liquid crystals typically have an isotropic transition temperature of about 165° F. (about 74° C.) or less. For example, the isotropic transition temperature of the liquid crystals can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.). One of skill in the art could select, without undue experimentation, liquid crystals that have desired transition temperatures.

Useful classes of liquid crystals include, for example, biphenyls (e.g., R-Ph-Ph-CN); terphenyls (e.g., R-Ph-Ph-Ph-CN); esters (e.g., R-PhC(O)O-Ph-OR′, R-PhC(O)O-Ph-CN, and R-PhC(O)O-Ph-Ph-CN); tolanes (e.g., R-Ph-CC-Ph-OR′); Schiffs bases (e.g., R-Ph-N═CH-Ph-OR′ and R—O-Ph-CH═N-Ph-CN); azo compounds (R-Ph-N═N-Ph-OR′); azoxy compounds (e.g., R-Ph-N═N+(O-)-Ph-OR′); and stilbenes (e.g., R-Ph-C(Cl)═CH-Ph-OR′), where each R and R′ independently represent an alkyl group. R is preferably a higher alkyl group, and typically at least a C7 alkyl group, and sometimes at least a C12 alkyl group. R′ is preferably a lower alkyl group, and typically a C1 or C2 alkyl group.

Examples of waxes that can be used for ultrasonic energy responsive fillers include dental waxes such as pattern wax, base-plate wax, sheet wax, impression wax, study wax, polycaprolactone, polyvinylacetate, ethylene-vinyl acetate copolymer, polyethylene glycol, esters of carboxylic acids with long chain alcohols (e.g., behenyl acrylate), esters of long chain carboxylic acids with long chain alcohols (e.g., beeswax, a non-polymeric wax), petroleum waxes, oxidized polyethylene wax (e.g., a wax available under the trade designation CERIDUST 3719 from Clariant Corp., Charlotte, N.C.), micronized, polar, high density polyethylene wax (e.g., a wax available under the trade designation CERIDUST 3731 from Clariant Corp., Charlotte, N.C.), carnauba wax (e.g., a wax available under the trade designation MIWAX from Michelman Incorporated, Cincinnati, Ohio), and combinations thereof (e.g., blends including two or more of microcystalline waxes, carnauba wax, ceresin, and beeswax). Useful waxes can also be oligomeric or polymeric. Useful waxes can be macrocrystalline or microcrystalline, natural or synthetic, and they may contain functional groups (e.g., carboxyl, alcohol, ester, ketone, and/or amide groups). Suitable waxes typically have low melt temperatures (e.g., about 165° F. (about 74° C.) or less). For example, the melt temperature of the wax can be in a range from about 165° F. (about 74° C.) to about 120° F. (about 49° C.), or from about 160° F. (about 71° C.) to about 130° F. (about 54° C.), or from about 155° F. (about 68° C.) to about 140° F. (about 60° C.). Suitable waxes can have a wide variety of physical properties. For example, at room temperature, physical properties of suitable waxes can range from kneadable to hard or brittle; coarse to crystalline; and/or transparent to opaque (with transparent being preferred).

Ultrasonic energy responsive fillers can preferably be incorporated into adhesive compositions of the present invention at levels effective to decrease the bond strength of the cured adhesive composition upon ultrasonic stimulation. Such levels of the additive also allow for sufficient adhesion during treatment process. Although levels of ultrasonic energy responsive filler will depend on the specific adhesive composition being used, typically the curable dental composition will include at least about 1 wt %, about 5 wt %, about 10 wt %, about 20 wt %, about 30 wt %, about 40 wt %, or even about 50 wt % of the ultrasonic energy responsive filler, based on the total weight of the curable adhesive composition. In some embodiments, the adhesive composition will include at most about 80 wt %, about 75 wt %, about 70 wt %, or even about 65 wt % of the ultrasonic energy responsive filler, based on the total weight of the adhesive composition.

Ultrasonic energy responsive fillers can be in a wide variety of forms including, for example, particles, powders, fibers, disks, plates, flakes, tubes, films, or combinations thereof. Typically the filler is in the form of a powder, which preferably has an average particle size in a range of about 0.2 μm to about 100 μm. For example, the average particle size of the ultrasonic energy responsive filler may be in a range from about 1 μm to about 50 μm, from about 2 μm to about 25 μm, or from about 5 μm to about 10 μm. As used herein for non-spherical particles, “particle size” refers to the smallest dimension of the particle.

In some embodiments, the ultrasonic energy responsive filler is distributed uniformly throughout the curable and/or cured adhesive composition. In other embodiments, especially for embodiments in which the curable adhesive composition is precoated on the base of an orthodontic appliance, the filler can be concentrated in a portion of the curable adhesive composition. For example, the ultrasonic energy responsive filler can be concentrated near one surface (e.g., the outer surface that will contact the tooth structure) to influence the fracture to occur near the tooth structure upon debonding. Ultrasonic energy responsive filler concentrated near one surface is meant to include fillers adhered to a surface of the curable or cured adhesive composition.

Polymerizable Monomer

The curable adhesive compositions of the present invention include a polymerizable monomer, thereby forming curable (e.g., polymerizable) compositions. The polymerizable monomer can include a wide variety of chemistries, such as ethylenically unsaturated compounds (with or without acid functionality), epoxy (oxirane) resins, vinyl ethers, glass ionomer cements, polyethers, polysiloxanes, and the like.

Ethylenically Unsaturated Compounds: The adhesive compositions of the present invention may include one or more curable components in the form of ethylenically unsaturated compounds with or without acid functionality, thereby forming curable compositions. Suitable curable compositions may include curable components (e.g., photopolymerizable compounds) that include ethylenically unsaturated compounds (which contain free radically active unsaturated groups). Examples of useful ethylenically unsaturated compounds include acrylic acid esters, methacrylic acid esters, hydroxy-functional acrylic acid esters, hydroxy-functional methacrylic acid esters, and combinations thereof.

The compositions (e.g., photopolymerizable compositions) may include compounds having free radically active functional groups that may include monomers, oligomers, and polymers having one or more ethylenically unsaturated group. Suitable compounds contain at least one ethylenically unsaturated bond and are capable of undergoing addition polymerization. Such free radically polymerizable compounds include mono-, di- or poly-(meth)acrylates (i.e., acrylates and methacrylates) such as, methyl (meth)acrylate, ethyl acrylate, isopropyl methacrylate, n-hexyl acrylate, stearyl acrylate, allyl acrylate, glycerol triacrylate, ethyleneglycol diacrylate, diethyleneglycol diacrylate, triethyleneglycol dimethacrylate, 1,3-propanediol di(meth)acrylate, trimethylolpropane triacrylate, 1,2,4-butanetriol trimethacrylate, 1,4-cyclohexanediol diacrylate, pentaerythritol tetra(meth)acrylate, sorbitol hexacrylate, tetrahydrofurfuryl (meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenolA di(meth)acrylate, and trishydroxyethyl-isocyanurate trimethacrylate; (meth)acrylamides (i.e., acrylamides and methacrylamides) such as (meth)acrylamide, methylene bis-(meth)acrylamide, and diacetone (meth)acrylamide; urethane (meth)acrylates; the bis-(meth)acrylates of polyethylene glycols (preferably of molecular weight 200-500), copolymerizable mixtures of acrylated monomers. Other suitable free radically polymerizable compounds include siloxane-functional (meth)acrylates. Mixtures of two or more free radically polymerizable compounds can be used if desired.

The polymerizable monomer may also contain hydroxyl groups and ethylenically unsaturated groups in a single molecule. Examples of such materials include hydroxyalkyl (meth)acrylates, such as 2-hydroxyethyl (meth)acrylate and 2-hydroxypropyl (meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta-(meth)acrylate; and 2,2-bis[4-(2-hydroxy-3-ethacryloxypropoxy)phenyl]propane (bisGMA). Suitable ethylenically unsaturated compounds are also available from a wide variety of commercial sources, such as Sigma-Aldrich, St. Louis. Mixtures of ethylenically unsaturated compounds can be used if desired.

In certain embodiments curable components include PEGDMA (polyethyleneglycol dimethacrylate having a molecular weight of approximately 400), bisGMA, UDMA (urethane dimethacrylate), GDMA (glycerol dimethacrylate), TEGDMA (triethyleneglycol dimethacrylate), bisEMA6 as described in U.S. Pat. No. 6,030,606 (Holmes), and NPGDMA (neopentylglycol dimethacrylate). Various combinations of the curable components can be used if desired.

Adhesive compositions of the present invention include at least about 5 wt %, e.g., at least about 10 wt %, or at least 15 wt % ethylenically unsaturated compounds, based on the total weight of the unfilled composition. The curable adhesive compositions of the present invention include at most 95 wt %, e.g., at most 90 wt %, or at most 80 wt % ethylenically unsaturated compounds, based on the total weight of the unfilled composition. The ethylenically unsaturated compounds may be without acid functionality.

Ethylenically Unsaturated Compounds with Acid Functionality: The curable adhesive compositions of the present invention may include one or more curable components in the form of ethylenically unsaturated compounds with acid functionality. As used herein, ethylenically unsaturated compounds with acid functionality is meant to include monomers, oligomers, and polymers having ethylenic unsaturation and acid and/or acid-precursor functionality. Acid-precursor functionalities include, for example, anhydrides, acid halides, and pyrophosphates. The acid functionality can include carboxylic acid functionality, phosphoric acid functionality, phosphonic acid functionality, sulfonic acid functionality, or combinations thereof.

Ethylenically unsaturated compounds with acid functionality include, for example, α,β-unsaturated acidic compounds such as glycerol phosphate mono(meth)acrylates, glycerol phosphate di(meth)acrylates, hydroxyethyl (meth)acrylate (e.g., HEMA) phosphates, bis((meth)acryloxyethyl)phosphate, ((meth)acryloxypropyl)phosphate, bis((meth)acryloxypropyl)phosphate, bis((meth)acryloxy)propyloxy phosphate, (meth)acryloxyhexyl phosphate, bis((meth)acryloxyhexyl)phosphate, (meth)acryloxyoctyl phosphate, bis((meth)acryloxyoctyl)phosphate, (meth)acryloxydecyl phosphate, bis((meth)acryloxydecyl)phosphate, caprolactone methacrylate phosphate, citric acid di- or tri-methacrylates, poly(meth)acrylated oligomaleic acid, poly(meth)acrylated polymaleic acid, poly(meth)acrylated poly(meth)acrylic acid, poly(meth)acrylated polycarboxyl-polyphosphonic acid, poly(meth)acrylated polychlorophosphoric acid, poly(meth)acrylated polysulfonate, poly(meth)acrylated polyboric acid, and the like, may be used as part or all of the polymerizable monomer component. Also monomers, oligomers, and polymers of unsaturated carbonic acids such as (meth)acrylic acids, aromatic (meth)acrylated acids (e.g., methacrylated trimellitic acids), and anhydrides thereof can be used. Certain preferred compositions of the present invention include an ethylenically unsaturated compound with acid functionality having at least one P—OH moiety.

According to certain embodiments, the curable adhesive compositions of the present invention may include at least 1 wt %, for example at least 3 wt %, or at least 5 wt % ethylenically unsaturated compounds with acid functionality, based on the total weight of the unfilled composition. The curable adhesive compositions of the present invention include at most 80 wt %, for example at most 70 wt % or at most 60 wt % ethylenically unsaturated compounds with acid functionality, based on the total weight of the unfilled composition.

Epoxy (Oxirane) or Vinyl Ether Compounds: The curable adhesive compositions of the present invention may include one or more curable components in the form of epoxy (oxirane) compounds (which contain cationically active epoxy groups) or vinyl ether compounds (which contain cationically active vinyl ether groups), thereby forming curable compositions. The epoxy or vinyl ether monomers can be used alone as the curable component in a dental composition or in combination with other monomer classes, e.g., ethylenically unsaturated compounds as described herein, and can include as part of their chemical structures aromatic groups, aliphatic groups, cycloaliphatic groups, and combinations thereof.

Examples of epoxy (oxirane) compounds include organic compounds having an oxirane ring that is polymerizable by ring opening. These materials include monomeric epoxy compounds and epoxides of the polymeric type and can be aliphatic, cycloaliphatic, aromatic or heterocyclic. These compounds generally have, on the average, at least 1 polymerizable epoxy group per molecule, in some embodiments at least 1.5, and in other embodiments at least 2 polymerizable epoxy groups per molecule. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds or may be mixtures of compounds containing one, two, or more epoxy groups per molecule. The “average” number of epoxy groups per molecule is determined by dividing the total number of epoxy groups in the epoxy-containing material by the total number of epoxy-containing molecules present.

These epoxy-containing materials may vary from low molecular weight monomeric materials to high molecular weight polymers and may vary greatly in the nature of their backbone and substituent groups. Illustrative of permissible substituent groups include halogens, ester groups, ethers, sulfonate groups, siloxane groups, carbosilane groups, nitro groups, phosphate groups, and the like. The molecular weight of the epoxy-containing materials may vary from 58 to 100,000 or more.

Other types of useful curable components having cationically active functional groups include vinyl ethers, oxetanes, spiro-orthocarbonates, spiro-orthoesters, and the like.

Both cationically active and free radically active functional groups may be contained in a single molecule. Such molecules may be obtained, for example, by reacting a di- or poly-epoxide with one or more equivalents of an ethylenically unsaturated carboxylic acid. An example of such a material is the reaction product of UVR-6105 (available from Union Carbide) with one equivalent of methacrylic acid. Commercially available materials having epoxy and free-radically active functionalities include the CYCLOMER series, such as CYCLOMER M-100, M-101, or A-200 available from Daicel Chemical, Japan, and EBECRYL-3605 available from Radcure Specialties, UCB Chemicals, Atlanta, Ga.

The cationically curable components may further include a hydroxyl-containing organic material. Suitable hydroxyl-containing materials may be any organic material having hydroxyl functionality of at least 1, and preferably at least 2. Preferably, the hydroxyl-containing material contains two or more primary or secondary aliphatic hydroxyl groups (i.e., the hydroxyl group is bonded directly to a non-aromatic carbon atom). The hydroxyl groups can be terminally situated, or they can be pendent from a polymer or copolymer. The molecular weight of the hydroxyl-containing organic material can vary from very low (e.g., 32) to very high (e.g., one million or more). Suitable hydroxyl-containing materials can have low molecular weights (i.e., from 32 to 200), intermediate molecular weights (i.e., from 200 to 10,000, or high molecular weights (i.e., above 10,000). As used herein, all molecular weights are weight average molecular weights.

The hydroxyl-containing materials may be non-aromatic in nature or may contain aromatic functionality. The hydroxyl-containing material may optionally contain heteroatoms in the backbone of the molecule, such as nitrogen, oxygen, sulfur, and the like. The hydroxyl-containing material may, for example, be selected from naturally occurring or synthetically prepared cellulosic materials. The hydroxyl-containing material should be substantially free of groups which may be thermally or photolytically unstable; that is, the material should not decompose or liberate volatile components at temperatures below 100° C. or in the presence of actinic light which may be encountered during the desired photopolymerization conditions for the polymerizable compositions.

The curable component(s) may also contain hydroxyl groups and cationically active functional groups in a single molecule. An example is a single molecule that includes both hydroxyl groups and epoxy groups.

Glass Ionomers Cements: The curable compositions of the present invention may include glass ionomer cements such as conventional glass ionomer cements that typically employ as their main ingredients a homopolymer or copolymer of an ethylenically unsaturated carboxylic acid (e.g., poly acrylic acid, copoly (acrylic, itaconic acid), and the like), a fluoroaluminosilicate (“FAS”) glass, water, and a chelating agent such as tartaric acid. Conventional glass ionomers (i.e., glass ionomer cements) typically are supplied in powder/liquid formulations that are mixed just before use. The mixture will undergo self-hardening in the dark due to an ionic reaction between the acidic repeating units of the polycarboxylic acid and cations leached from the glass.

The glass ionomer cements may also include resin-modified glass ionomer (“RMGI”) cements. Like a conventional glass ionomer, an RMGI cement employs an FAS glass. However, the organic portion of an RMGI is different. In one type of RMGI, the polycarboxylic acid is modified to replace or end-cap some of the acidic repeating units with pendent curable groups and a photoinitiator is added to provide a second cure mechanism, e.g., as described in U.S. Pat. No. 5,130,347 (Mitra). Acrylate or methacrylate groups are usually employed as the pendant curable group. In another type of RMGI, the cement includes a polycarboxylic acid, an acrylate or methacrylate-functional monomer and a photoinitiator. In another type of RMGI, the cement may include a polycarboxylic acid, an acrylate or methacrylate-functional monomer, and a redox or other chemical cure system. RMGI cements are preferably formulated as powder/liquid or paste/paste systems, and contain water as mixed and applied. The compositions are able to harden in the dark due to the ionic reaction between the acidic repeating units of the polycarboxylic acid and cations leached from the glass, and commercial RMGI products typically also cure on exposure of the cement to light from a dental curing lamp.

Polyethers or Polysiloxanes (i.e., Silicones): Dental impression materials are typically based on polyether or polysiloxane (i.e. silicone) chemistry. Polyether materials typically consist of a two-part system that includes a base component (e.g., a polyether with ethylene imine rings as terminal groups) and a catalyst (or accelerator) component (e.g., an aryl sulfonate as a cross-linking agent). Polysiloxane materials also typically consist of a two-part system that includes a base component (e.g., a polysiloxane, such as a dimethylpolysiloxane, of low to moderately low molecular weight) and a catalyst (or accelerator) component (e.g., a low to moderately low molecular weight polymer with vinyl terminal groups and chloroplatinic acid catalyst in the case of addition silicones; or a liquid that consists of stannous octanoate suspension and an alkyl silicate in the case of condensation silicones). Both systems also typically contain a filler, a plasticizer, a thickening agent, a coloring agent, or mixtures thereof.

Examples of commercial polyether and polysiloxane impression materials include, but are not limited to, IMPREGUM Polyether Materials, PERMADYNE Polyether Materials, EXPRESS Vinyl Polysiloxane Materials, DIMENSION Vinyl Polysiloxane Materials, and IMPRINT Vinyl Polysiloxane Materials; all available from 3M ESPE (St. Paul, Minn.). Other exemplary polyether, polysiloxane (silicones), and polysulfide impression materials are discussed in the following reference: Restorative Dental Materials, Tenth Edition, edited by Robert G. Craig and Marcus L. Ward, Mosby-Year Book, Inc., St. Louis, Mo., Chapter 11

### (Impression Materials).

Curing Initiators

Photoinitiator Systems: In certain embodiments, the compositions of the present invention are photopolymerizable, i.e., the compositions contain a photopolymerizable component and a photoinitiator (i.e., a photoinitiator system) that upon irradiation with actinic radiation initiates the polymerization (or hardening) of the composition. Such photopolymerizable compositions can be free radically polymerizable or cationically polymerizable.

Suitable photoinitiators (i.e., photoinitiator systems that include one or more compounds) for polymerizing free radically photopolymerizable compositions include binary and tertiary systems. Typical tertiary photoinitiators include an iodonium salt, a photosensitizer, and an electron donor compound as described in U.S. Pat. No. 5,545,676 (Palazzotto et al.). Exemplary iodonium salts are the diaryl iodonium salts, e.g., diphenyliodonium chloride, diphenyliodonium hexafluorophosphate, diphenyliodonium tetrafluoroborate, and tolylcumyliodonium tetrakis(pentafluorophenyl)borate. Exemplary photosensitizers are monoketones and diketones (e.g., alpha diketones) that absorb some light within a range of 400 nm to 520 nm (e.g., 450 nm to 500 nm). Camphorquinone, benzil, furil, 3,3,6,6-tetramethylcyclohexanedione, phenanthraquinone, 1-phenyl-1,2-propanedione and other 1-aryl-2-alkyl-1,2-ethanediones, and cyclic alpha diketones are suitable for the curable adhesive composition. Exemplary electron donor compounds include substituted amines, e.g., ethyl dimethylaminobenzoate. Other suitable tertiary photoinitiator systems useful for photopolymerizing cationically polymerizable resins are described, for example, in U.S. Pat. No. 6,765,036 (Dede et al.).

Other suitable photoinitiators for polymerizing free radically photopolymerizable compositions include the class of phosphine oxides that typically have a functional wavelength range of 380 nm to 1200 nm. Phosphine oxide free radical initiators with a functional wavelength range of 380 nm to 450 nm include acyl and bisacyl phosphine oxides such as those described in U.S. Pat. No. 4,298,738 (Lechtken et al.), U.S. Pat. No. 4,324,744 (Lechtken et al.), U.S. Pat. No. 4,385,109 (Lechtken et al.), U.S. Pat. No. 4,710,523 (Lechtken et al.), and U.S. Pat. No. 4,737,593 (Ellrich et al.), U.S. Pat. No. 6,251,963 (Kohler et al.); and EP Application No. 0 173 567 A2 (Ying). Commercially available phosphine oxide photoinitiators capable of free-radical initiation when irradiated at wavelength ranges of greater than 380 nm to 450 nm include bis(2,4,6-trimethylbenzoyl)phenyl phosphine oxide (IRGACURE 819, Ciba Specialty Chemicals, Tarrytown, N.Y.), bis(2,6-dimethoxybenzoyl)-(2,4,4-trimethylpentyl) phosphine oxide (CGI 403, Ciba Specialty Chemicals), a 25:75 mixture, by weight, of bis(2,6-dimethoxybenzoyl)-2,4,4-trimethylpentyl phosphine oxide and 2-hydroxy-2-methyl-1-phenylpropan-1-one (IRGACURE 1700, Ciba Specialty Chemicals), a 1:1 mixture, by weight, of bis(2,4,6-trimethylbenzoyl)phenyl phosphine oxide and 2-hydroxy-2-methyl-1-phenylpropane-1-one (DAROCUR 4265, Ciba Specialty Chemicals), and ethyl 2,4,6-trimethylbenzylphenyl phosphinate (LUCIRIN LR8893X, BASF Corp., Charlotte, N.C.). Typically, the phosphine oxide initiator is present in the photopolymerizable composition in catalytically effective amounts, such as from about 0.1 wt % to about 5.0 wt %, based on the total weight of the composition.

Tertiary amine reducing agents may be used in combination with an acylphosphine oxide. Illustrative tertiary amines useful in the invention include ethyl 4-(N,N-dimethylamino)benzoate and N,N-dimethylaminoethyl methacrylate. When present, the amine reducing agent is present in the photopolymerizable composition in an amount from 0.1 wt % to 5.0 wt %, based on the total weight of the composition. Useful amounts of other initiators are well known to those of skill in the art.

Suitable photoinitiators for polymerizing cationically photopolymerizable compositions include binary and tertiary systems. Typical tertiary photoinitiators include an iodonium salt, a photosensitizer, and an electron donor compound as described in EP 0 897 710 (Weinmann et al.); in U.S. Pat. No. 5,856,373 (Kaisaki et al.), U.S. Pat. No. 6,084,004 (Weinmann et al.), U.S. Pat. No. 6,187,833 (Oxman et al.), and U.S. Pat. No. 6,187,836 (Oxman et al.); and in U.S. Pat. No. 6,765,036 (Dede et al.). The compositions of the invention can include one or more anthracene-based compounds as electron donors. In some embodiments, the compositions comprise multiple substituted anthracene compounds or a combination of a substituted anthracene compound with unsubstituted anthracene. The combination of these mixed-anthracene electron donors as part of a photoinitiator system provides significantly enhanced cure depth and cure speed and temperature insensitivity when compared to comparable single-donor photoinitiator systems in the same matrix.

Suitable iodonium salts include tolylcumyliodonium tetrakis(pentafluorophenyl)borate, tolylcumyliodonium tetrakis(3,5-bis(trifluoromethyl)-phenyl)borate, and the diaryl iodonium salts, e.g., diphenyliodonium chloride, diphenyliodonium hexafluorophosphate, diphenyliodonium hexafluoroantimonate, and diphenyliodonium tetrafluoroboarate.

The curing initiator system is present in an amount sufficient to provide the desired rate of hardening (e.g., polymerizing and/or crosslinking). For a photoinitiator, this amount will be dependent in part on the light source, the thickness of the layer to be exposed to radiant energy, and the extinction coefficient of the photoinitiator. The initiator system may be present in a total amount of at least 0.01 wt %, e.g., at least 0.03 wt %, or at least 0.05 wt %, based on the total weight of the composition. The initiator system may be present in a total amount of no more than 10 wt %, e.g., no more than 5 wt %, or no more than 2.5 wt %, based on the total weight of the composition.

Redox Initiator Systems: In certain embodiments, the compositions of the present invention are chemically curable, i.e., the compositions contain a chemically curable component and a chemical initiator (i.e., initiator system) that can polymerize, cure, or otherwise harden the composition without dependence on irradiation with actinic radiation. Such chemically curable compositions are sometimes referred to as “self-cure” compositions and may include glass ionomer cements, resin-modified glass ionomer cements, redox cure systems, and combinations thereof.

The chemically curable compositions may include redox cure systems that include a curable component (e.g., an ethylenically unsaturated polymerizable component) and redox agents that include an oxidizing agent and a reducing agent. Suitable curable components, redox agents, optional acid-functional components, and optional fillers that are useful in the present invention are described in U.S. Pat. Publication Nos. 2003/0166740 (Mitra et al.) and 2003/0195273 (Mitra et al.).

The reducing and oxidizing agents should react with or otherwise cooperate with one another to produce free-radicals capable of initiating polymerization of the resin system (e.g., the ethylenically unsaturated component). This type of cure is a dark reaction, that is, it is not dependent on the presence of light and can proceed in the absence of light. The reducing and oxidizing agents are preferably sufficiently shelf-stable and free of undesirable colorization to permit their storage and use under typical dental conditions. They should be sufficiently miscible with the resin system (and preferably water-soluble) to permit ready dissolution in (and discourage separation from) the other components of the curable composition.

Useful reducing agents include ascorbic acid, ascorbic acid derivatives, and metal complexed ascorbic acid compounds as described in U.S. Pat. No. 5,501,727 (Wang et al.); amines, especially tertiary amines, such as 4-tert-butyl dimethylaniline; aromatic sulfinic salts, such as p-toluenesulfinic salts and benzenesulfinic salts; thioureas, such as 1-ethyl-2-thiourea, tetraethyl thiourea, tetramethyl thiourea, 1,1-dibutyl thiourea, and 1,3-dibutyl thiourea; and mixtures thereof. Other secondary reducing agents may include cobalt (II) chloride, ferrous chloride, ferrous sulfate, hydrazine, hydroxylamine (depending on the choice of oxidizing agent), salts of a dithionite or sulfite anion, and mixtures thereof.

Suitable oxidizing agents will also be familiar to those skilled in the art, and include but are not limited to persulfuric acid and salts thereof, such as sodium, potassium, ammonium, cesium, and alkyl ammonium salts. Additional oxidizing agents include peroxides such as benzoyl peroxides, hydroperoxides such as cumyl hydroperoxide, t-butyl hydroperoxide, and amyl hydroperoxide, as well as salts of transition metals such as cobalt (III) chloride and ferric chloride, cerium (IV) sulfate, perboric acid and salts thereof, permanganic acid and salts thereof, perphosphoric acid and salts thereof, and mixtures thereof.

It may be desirable to use more than one oxidizing agent or more than one reducing agent. Small quantities of transition metal compounds may also be added to accelerate the rate of redox cure. In some embodiments it may be preferred to include a secondary ionic salt to enhance the stability of the polymerizable composition as described in U.S. Pat. Publication No. 2003/0195273 (Mitra et al.).

The reducing and oxidizing agents are present in amounts sufficient to permit an adequate free-radical reaction rate. This can be evaluated by combining all of the ingredients of the curable composition except for the optional filler, and observing whether or not a cured mass is obtained. The reducing agent may be present in an amount of at least 0.01 wt %, e.g., at least 0.1% by weight, based on the total weight of the curable adhesive composition. The reducing agent may be present in an amount of no greater than 10 wt %, e.g., no greater than 5 wt %, based on the total weight of the curable adhesive composition. Similarly, the oxidizing agent may be present in an amount of at least 0.01 wt %, e.g., at least 0.1% by weight, based on the total weight of the curable adhesive composition. The oxidizing agent may be present in an amount of no greater than 10 wt %, e.g., no greater than 5 wt %, based on the total weight of the curable adhesive composition.

The reducing or oxidizing agents can be microencapsulated, which will generally enhance shelf stability of the curable composition, and if necessary permit packaging the reducing and oxidizing agents together. For example, through appropriate selection of an encapsulant, the oxidizing and reducing agents can be combined with an acid-functional component and optional filler and kept in a storage-stable state. Likewise, through appropriate selection of a water-insoluble encapsulant, the reducing and oxidizing agents can be combined with an FAS glass and water and maintained in a storage-stable state.

Other Fillers

The compositions of the present invention can optionally contain other fillers in addition to the ultrasonic energy responsive fillers. Fillers may be selected from one or more of a wide variety of materials suitable for incorporation in compositions used for dental applications, such as fillers currently used in dental restorative compositions, and the like.

The filler is preferably finely divided. The filler can have a unimodial or polymodial (e.g., bimodal) particle size distribution. The maximum particle size (the largest dimension of a particle, typically, the diameter) of the filler is less than 20 μm, for example less than 10 μm, or less than 5 μm. In one embodiment, the average particle size of the filler is less than 0.1 μm, for example less than 0.075 μm.

The filler can be an inorganic material. It can also be a crosslinked organic material that is insoluble in the resin system (i.e., the curable components), and may be optionally filled with inorganic filler (i.e., a composite filler). The filler should in any event be nontoxic and suitable for use in the mouth. The filler can be radiopaque or radiolucent. The filler typically is substantially insoluble in water.

Examples of suitable inorganic fillers are naturally occurring or synthetic materials including, but not limited to: quartz (i.e., silica, SiO₂); nitrides (e.g., silicon nitride); glasses and fillers derived from, for example, Zr, Sr, Ce, Sb, Sn, Ba, Zn, and Al; feldspar; borosilicate glass; kaolin; talc; zirconia; titania; and submicron silica particles (e.g., pyrogenic silicas such as those available under the trade designations AEROSIL, including “OX 50,” “130,” “150” and “200” silicas from Degussa Corp., Akron, Ohio, and CAB-O-SIL M5 silica from Cabot Corp., Tuscola, Ill.). Examples of suitable organic filler particles include filled or unfilled pulverized polycarbonates, polyepoxides, and the like.

The filler can also be an acid-reactive filler. Suitable acid-reactive fillers include metal oxides, glasses, and metal salts. Typical metal oxides include barium oxide, calcium oxide, magnesium oxide, and zinc oxide. Typical glasses include borate glasses, phosphate glasses, and fluoroaluminosilicate (“FAS”) glasses. FAS glasses are particularly preferred. The FAS glass typically contains sufficient elutable cations so that a cured dental composition will form when the glass is mixed with the components of the curable composition. The glass also typically contains sufficient elutable fluoride ions so that the cured composition will have cariostatic properties. The glass can be made from a melt containing fluoride, alumina, and other glass-forming ingredients using techniques familiar to those skilled in the FAS glassmaking art. The FAS glass typically is in the form of particles that are sufficiently finely divided so that they can conveniently be mixed with the other cement components and will perform well when the resulting mixture is used in the mouth.

Generally, the average particle size (typically, diameter) for the FAS glass is no greater than 12 μm, typically no greater than 10 μm, and more typically no greater than 5 μm as measured using, for example, a sedimentation analyzer. Suitable FAS glasses will be familiar to those skilled in the art, and are available from a wide variety of commercial sources, and many are found in currently available glass ionomer cements such as those commercially available under the trade designations VITREMER, VITREBOND, RELY X LUTING CEMENT, RELY X LUTING PLUS CEMENT, PHOTAC-FIL QUICK, KETAC-MOLAR, and KETAC-FIL PLUS (3M ESPE Dental Products, St. Paul, Minn.), FUJI II LC and FUJI IX (G-C Dental Industrial Corp., Tokyo, Japan) and CHEMFIL Superior (Dentsply International, York, Pa.). Mixtures of fillers can be used if desired.

The surface of the filler particles can also be treated with a coupling agent in order to enhance the bond between the filler and the resin. The use of suitable coupling agents include gamma-methacryloxypropyltrimethoxysilane, gamma-mercaptopropyltriethoxysilane, gamma-aminopropyltrimethoxysilane, and the like. Silane-treated zirconia-silica (ZrO₂—SiO₂) filler, silane-treated silica filler, silane-treated zirconia filler, and combinations thereof are especially preferred in certain embodiments. Other suitable fillers include nanosized silica particles, nanosized metal oxide particles, and combinations thereof.

Where the filler component further includes the inorganic filler, organic filler, or composite filler, the ratio of the volume percent of the ultrasonic energy responsive filler to the other filler(s) is greater than about 1. For example, the ratio of the volume percent of the ultrasonic energy responsive filler to the inorganic filler may be in a range of about 1:1 to 9:1. For example, the ratio of the volume percent of the ultrasonic energy responsive filler to the composite filler may be in a range of about 1:1 to 9:1.

Optional Photobleachable and/or Thermochromic Dyes

In some embodiments, compositions of the present invention preferably have an initial color remarkably different than dental structures. Color can be imparted to the curable adhesive composition through the use of a photobleachable or photochromic dye. The composition can include at least 0.001 wt % photobleachable or photochromic dye, e.g., at least 0.002 wt % photobleachable or photochromic dye, based on the total weight of the composition. The composition may include at most 1% by weight photobleachable or photochromic dye, e.g., at most 0.1% by weight photobleachable or photochromic dye, based on the total weight of the composition. The amount of photobleachable and/or photochromic dye may vary depending on its extinction coefficient, the ability of the human eye to discern the initial color, and the desired color change. Suitable photobleachable dyes are disclosed, for example, in U.S. Pat. No. 6,670,436 (Burgath et al.).

For embodiments including a photobleachable dye, the color formation and bleaching characteristics of the photobleachable dye varies depending on a variety of factors including, for example, acid strength, dielectric constant, polarity, amount of oxygen, and moisture content in the atmosphere. However, the bleaching properties of the dye can be readily determined by irradiating the composition and evaluating the change in color. Exemplary photobleachable dyes include, for example, Rose Bengal, Methylene Violet, Methylene Blue, Fluorescein, Eosin Yellow, Eosin Y, Ethyl Eosin, Eosin bluish, Eosin B, Erythrosin B, Erythrosin Yellowish Blend, Toluidine Blue, 4′,5′-Dibromofluorescein, or combinations thereof.

Miscellaneous Optional Additives: Optionally, the adhesive compositions of the present invention may contain solvents (e.g., alcohols (e.g., propanol, ethanol), ketones (e.g., acetone, methyl ethyl ketone), esters (e.g., ethyl acetate), other nonaqueous solvents (e.g., dimethylformamide, dimethylacetamide, dimethylsulfoxide, 1-methyl-2-pyrrolidinone)), and water. If desired, the compositions of the invention can contain additives such as indicators, dyes, pigments, inhibitors, accelerators, viscosity modifiers, wetting agents, buffering agents, stabilizers, and other similar ingredients that will be apparent to those skilled in the art. Viscosity modifiers include the thermally responsive viscosity modifiers (such as PLURONIC F-127 and F-108 available from BASF Wyandotte Corporation, Parsippany, N.J.) and may optionally include a polymerizable moiety on the modifier or a polymerizable component different than the modifier. Such thermally responsive viscosity modifiers are described in U.S. Pat. No. 6,669,927 (Trom et al.) and U.S. Pat. Publication No. 2004/0151691 (Oxman et al.).

Additionally, medicaments or other therapeutic substances can be optionally added to the dental compositions. Examples include, but are not limited to, fluoride sources, whitening agents, anticaries agents (e.g., xylitol), calcium sources, phosphorus sources, remineralizing agents (e.g., calcium phosphate compounds), enzymes, breath fresheners, anesthetics, clotting agents, acid neutralizers, chemotherapeutic agents, immune response modifiers, thixotropes, polyols, anti-inflammatory agents, antimicrobial agents (in addition to the antimicrobial lipid component), antifungal agents, agents for treating xerostomia, desensitizers, and the like, of the type often used in dental compositions. Combination of any of the above additives may also be employed.

Methods

Curable and cured adhesive compositions of the present invention (e.g., compositions that in certain embodiments include a ultrasonic energy responsive filler) can be used for a variety of dental and orthodontic applications that utilize a material capable of adhering (e.g., bonding) to a tooth structure, and which it is desired that the cured adhesive composition be removed from the tooth structure at some point in time. Uses for such curable and cured adhesive compositions include, for example, uses as adhesives (e.g., dental and/or orthodontic adhesives), cements (e.g., glass ionomer cements, resin-modified glass ionomer cements, and orthodontic cements), primers (e.g., orthodontic primers), restoratives, liners, sealants (e.g., orthodontic sealants), coatings, and combinations thereof.

An orthodontic appliance having a curable adhesive composition of the present on the base thereof may be bonded to a tooth structure using methods (e.g., direct or indirect bonding methods) that are well known in the art. Upon application of the orthodontic appliance to the tooth structure, the curable adhesive composition of the present invention can be cured to adhere the orthodontic appliance to the tooth structure. A variety of suitable methods of hardening the composition are known in the art. For example, in some embodiments the curable adhesive composition can be cured by exposure to UV or visible light. In other embodiments, the curable adhesive composition can be provided as a multi-part composition that hardens upon combining the two or more parts.

When desired, typically upon completion of the orthodontic treatment process, the practitioner needs to remove the orthodontic appliance from the tooth structure. Cured adhesive compositions of the present invention are designed to reduce the bond strength upon ultrasonic stimulation to allow for convenient removal of not only the orthodontic appliance, but also for removal of any cured dental composition remaining on the tooth structure after removal of the appliance.

Accordingly, the cured adhesive composition can be treated with ultrasonic energy by contacting the orthodontic appliance, the cured composition, or combinations thereof with a suitable ultrasonic device. The ultrasonic device can be equipped with a linear oscillator and a tip assembly configured to engage or clasp onto the orthodontic appliance. One exemplary ultrasonic device is Kayo Piezito ultrasonic unit (Kayo, Federal Republic of Germany), which operates at maximum power of 10 watts over a frequency range of about 25 kHz to about 35 kHz.

The ultrasonic stimulation is maintained for a time sufficient to result in the desired decrease in bond strength. In certain embodiments, the time is at most 10 minutes, sometimes at most 10 seconds, and other times at most 1 second. The decrease in bond strength typically results in fracture within the cured composition layer.

In some embodiments, the orthodontic appliance includes an additional dental composition layer. Such additional dental composition layers can include, for example, uncured or cured dental compositions (e.g., in certain embodiments, a conventional dental composition not including a ultrasonic energy responsive filler). The inclusion of additional layers can influence, for example, where fracture takes place during debonding of the orthodontic appliance from the tooth structure, as described herein below.

Objects and advantages of this invention are further illustrated by the following examples, but the particular materials and amounts thereof recited in these examples, as well as other conditions and details, should not be construed to unduly limit this invention. Unless otherwise indicated, all parts and percentages are on a weight basis, all water is deionized water, and all molecular weights are weight average molecular weight.

### EXAMPLES

### Example 1

A light curable orthodontic resin composition is prepared as follows: Bis GMA 50.0 wt %; ethoxylated bisphenol A dimethacrylate 49.4 wt %; camphorquinone 0.2 wt %; and ethyldimethylamino benzoate 0.4 wt %. The resin mixture (A) is stirred at room temperature until homogeneous and all particulate is dissolved yielding a light yellow transparent viscous liquid. A light curable orthodontic adhesive paste composition (B) is prepared as follows: Resin mixture A—50 wt %, and particulate polymethylmethacrylate (catalog no. H003 0000, Esstech, Essington, Pa.) 50 wt %. The resin is placed in suitable composite blending equipment, e.g., DAC Speed mixer (Flack Tek, Landrum, S.C.). The resulting resin composite is a paste-like consistency having similar body, texture, slumping and appearance characteristics as commercial product Ormco Enlight bonding adhesive.

De-bond strength test: The adhesive composition (B) is used to bond Ormco Orthos® Upper lateral stainless steel orthodontic brackets to bovine enamel. Individual bovine teeth are embedded in acrylic fixtures with the facial exposed. The teeth are prepared for bonding by etching for 30 seconds with 37% phosphoric acid, rinsing with water for 5 seconds, then air drying with contaminant free compressed air for a few seconds until the surface is dry and has a frosty appearance. Ormco Ortho Solo sealant is painted sparingly onto the etched area, then the paste B is applied and spread over the entire mesh bonding pad of a Orthos® bracket. The bracket is then positioned onto the sealed enamel and seated with even and firm pressure. The excess adhesive is removed from the bracket periphery and the assembly is light cured using a Demetron 501 dental curing light with minimum output 500 mW/cm² for 40 seconds. The bonding procedure is repeated for each bracket specimen. A control set of bonded specimens in prepared in the same manner, where Enlight bonding adhesive is substituted for composition B. Both the composition B group and the control group are placed in 37° C. water for 24 hours.

An lnstron 1122 (lnstron, Canton, Mass.) physical test machine set to crosshead speed of 0.1 inch/min and 100 N load cell is used to measure the de-bond forces (i.e., the shear bond strength (SBS)). A specially designed fixture is used to hold each specimen so that the facial surface of the enamel is parallel to the applied force. The fixture rests on a horizontal platen beneath the crosshead. A blade-type attachment is fitted to the crosshead allowing the force to be applied downward to the incisal tie wings of the Orthos® bracket. For the composition B group, a Kayo ultrasonic unit (Kayo, Federal Republic of Germany) is used to energize the bracket bond as the lnstron loading initiates. Researchers have reported in the literature bonding strength values (SBS) of 9 to 11 MPa may cause enamel damage.

Adhesive Remnant Index (ARI) measures the amount of adhesive left on the tooth after the bracket is de-bonded:
0—No adhesive left on tooth. High risk situation where enamel damage may occur and does normally involve loss of microscopic enamel fragments.
1—Less than 50% of the adhesive left on the tooth.
2—More than 50% of the adhesive left on the tooth.
3—All adhesive left on the tooth with appearance of mesh imprint. Least likely scenario for enamel damage since the de-bond is away from the enamel surface.

The actual results obtained with the light curable orthodontic adhesive paste composition B and Orthos® bracket were: About 5 MPa without ultrasonic energy; about 1 MPa when 3 to 4 seconds ultrasonic energy was applied; and less than 0.5 MPa when 4 to 6 seconds of ultrasonic energy was applied.

The actual results obtained with Enlight adhesive control and Orthos® bracket were: About 9 MPa without ultrasonic energy and about 7 MPa with 5 seconds of ultrasonic activation.

In both instances, the ultrasonic unit was a TTT “Piezito” (Tip Top Tips, Switzerland) conventional dental hygiene scaler fitted with their DaSupra tip and power setting at 100%. The tip was inserted in the bracket slot and triggered on for the times noted, while concurrently the Instron monitored the force applied to the tie wings.

The results of Experiment 1 suggest (1) higher strength reinforcing filler (e.g., glass filler or a different polymer) is needed in at least a partial replacement of the PMMA filler, so that the clinical bond strength is adjusted to over 7 MPa; and (2) the results demonstrate the reduction of bond strength is achievable under ultrasonic activation.

### Example 2

To evaluate the inclusion of higher strength reinforcing fillers, the experiment of Example 1 is to be repeated with the same Resin mixture A and PMMA filler, but the adhesive composition (Composition C) would further include a particulate aluminoborosilcate (dental glass)-20 wt %. The ultrasonic unit would not be used during the de-bond test. The EXPECTED de-bond strengths are as follows:

Adhesive Composition C: greater than about 10 MPa; ARI=about 2.

Enlight Control: about 12 MPa; ARI=1.

The bond strength value for clinical success is widely accepted as a minimum of 6-8 MPa. The expected results of Example 2 would indicate the inventive composition may be used as a conventional bonding adhesive equivalent to current commercial state-of-the-art adhesives with high confidence that bond integrity would not be sacrificed.

### Example 3

A paste composition will be prepared exactly as in Example 2. However, a particulate quartz (silicon dioxide) filler will be used in place of the particulate aluminoborosilicate. The resulting adhesive paste should have the handling (body, texture, slumping, clean-up, tacky-ness) and appearance characteristics similar to commercial product Transbond XT (3M/Unitek, Monrovia, Calif.). The characteristics of the adhesive during the bonding procedure should have essentially the same feel and subjective user properties as Transbond XT demonstrating the inventive composite may be formulated as transparently interchangeable with virtually any commercial product, and may be used as such with confidence even if the user decides to de-bond conventionally without the advantage of reducing the strength by use of an ultrasonic device. The strength and ARI with and without using the ultrasonic energy are expected to be similar to the expected results of composition B in examples 1 and 2, respectively.

In one exemplary arrangement, a laminated adhesive configuration is provided in which the bracket's adhesive faying surface (e.g., bonding surface) is in direct contact with a high percentage inventive composition. A lower percentage inventive composition, or preferably an adhesive void of any ultrasonic energy responsive filler (i.e., a commercial orthodontic adhesive of clinician's choice), may then be used over this high percentage inventive adhesive layer to attach the bracket to the tooth. In this way, the de-bond interface can be accurately controlled by (1) the high percentage inventive composition can be designed to match the bracket type, e.g. high strength for conventional twin mesh brackets, and a lower strength for more rigid type bases, and (2) when used in conjunction with ultrasonic energy stimulation, the high percentage inventive composition layer at the bracket interface will soften and release the bracket leaving the bulk of the commercial adhesive remaining on the tooth. This particular arrangement is particularly useful for an appliance that would be offered by the manufacturer with an adhesive pre-applied at the factory. The so-called “adhesive pre-coat”, or “pre-coated bracket” may be offered with just the inventive adhesive layer so that the clinician can use their preferred adhesive for tooth side attachment, or may be offered as the complete assembly ready for tooth attachment, but with limited factory available adhesive choice only. Alternatively, the inventive adhesive composition may be offered as a separately packaged paste in, e.g., a syringe delivery scheme, ready to be dispensed to the bracket bonding surface.

### Example 4

The manufacturer may control the debond strength by factory application of the bonding adhesive (“Pre-Coated” bracket). A light curable orthodontic adhesive paste composition can be prepared as follows: Example 1 Resin mixture A—30 wt %; and Particulate polylactic acid—70 wt %.

The paste is applied to an Ormco Inspire Ice™ (alumina) ceramic bracket bonding base in a very thin layer that sufficiently covers (up to approximately 10 μm) the ball base mechanical interlocking design. To this layer is added Enlight adhesive, approximately 10 mg or a thickness of approximately 0.5 mm in a relatively homogeneously thick layer. The assembly is packaged in an actinic light-free container ready for shipment to the clinician. The shear bond strength (SBS) of the pre-coated Ice bracket is tested. The de-bonding strength test described in Example 1 is followed, where etched bovine, Ortho Solo sealant, and a Demetron curing light are used, and the brackets are de-bonded using an lnstron test machine.

Adhesive Composition B paste was used to bond Ormco Inspire Ice™ lower anterior brackets to etched bovine enamel. Bovine was prepared as previously described including Ortho Solo sealant, then the Inspire Ice™ bracket with Composition B on the base was positioned, seated, cleaned of flash, and light cured for 40 seconds. After 24 hours in 37 C water, the SBS was tested, under various ultrasonic activation conditions:

No ultrasonic activation: 13 MPa; 3-5 seconds ultrasonic activation: 5-7 MPa.

Enlight control on Inspire Ice™ bracket, no ultrasonic energy: 11 MPa; Enlight control on Inspire Ice™ bracket with 4-6 seconds ultrasonic energy: 11 MPa.

The results suggest: (1) The composition may need to be modified to allow a lower debond force when ultrasonic is applied and/or the ultrasonic device/tip design may need modification to more effectively transmit appropriate energy, and (2) results demonstrate a significant reduction in bond strength to a force level that has a much lower level of enamel fracture risk.

Ceramic brackets are universally accepted to be the highest risk and known offenders of enamel damage. Slight deformation of a bracket pad is normally possible for more flexible brackets like metal and plastic. The deformation allows a crack to develop through the adhesive leading to catastrophic (bond) failure. However, ceramic brackets have inherently extremely high modulus and strength and there is no ability to deform or deflect the base area of the bracket at the interface of the adhesive layer. The likelihood to form a stress riser at the adhesive layer so that a crack will initiate is dependent on the skill of the operator and the design of the tool. In the worst case scenario, the bracket, enamel, or both will fracture. The expected results of Example 4 can demonstrate that the manufacturer can greatly reduce the risk of their product causing damage and/or poor product performance image, while at the same time provide a convenient pre-coated delivery system and reliable bond properties.

Persons skilled in the art will appreciate that widely known additives can be included to effect certain enhancements and this will not affect the bond strength reducing properties afforded by the ultrasonic energy responsive filler. These additives can include but are not limited to fluoride, calcium phosphate, bond enhancement chemistry, colorants, UV stabilizers, and co-initiators to improve the working time and/or curing character.

### Example 5

Example 1 resin and paste can be supplemented with various prior art adjuncts to allow better user interface, improved hygiene, and robust bond integrity. In this regard, a reversible colorant can be added to help visual placement and clean-up procedures, synergistic initiators are included to improve the working and setting characteristics, and bioactive glass (calcium phosphate including fluoride) can be substituted for a portion of the particulate aluminoborosilicate glass to reduce decalcification and aid remineralization. The bond strength and de-bond characteristics are not expected to change significantly. Example 5 would demonstrate that the inventive composition may be formulated with secondary characteristics equivalent to current state-of-the-art high performance adhesive materials.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and/or method and examples shown and described. The various features of exemplary embodiments described herein may be used in any combination. Accordingly, departures may be made from such details without departing from the scope of the general inventive concept.

What we claim is:

1. An adjustable orthodontic bracket comprising:
a body member comprising an orthodontic archwire fixing member for fixing one or more orthodontic archwires in a position such that a predetermined stress is generated and applied to a tooth to be treated, and a first faying surface;
a bonding base member for bonding the adjustable orthodontic bracket to a buccal or lingual side of the tooth to be treated, comprising a second faying surface and a tooth bonding surface; and
a connecting member comprising a layer of a thermoplastic polymer, which connects the first faying surface of the body member to the second faying surface of the bonding base member.

2. The bracket of claim 1, wherein the thermoplastic polymer is selected from the group consisting of semicrystalline polymers, amorphous polymers, and combinations thereof.

3. The bracket of claim 1, wherein the thermoplastic polymer is a methyl methacrylate-hydroxyethylmethacrylate copolymer.

4. The bracket of claim 1, wherein the thermoplastic polymer has a heat distortion temperature (HDT) value, a melt transition temperature (Tm) value, or a glass transition temperature (Tg) value of about 165° F. (about 74° C.) or less.

5. The bracket of claim 1, wherein at least one of the first or the second faying surfaces comprises a laser etched portion.

6. The bracket of claim 1, wherein the body member is configured to engage with a working end of an ultrasonic energy device.

7. A method of repositioning the adjustable orthodontic bracket of claim 1, comprising:
engaging the body member with a working end of an ultrasonic energy device;
supplying ultrasonic energy to the body member that passes through the body member to the connecting member comprising the layer of the thermoplastic polymer, thereby increasing a temperature of the thermoplastic polymer above a softening temperature;
repositioning the body member relative to a stationary bonding base member adhered to a surface of a tooth structure; and
terminating the transmission of ultrasonic energy thereby allowing the temperature of the thermoplastic polymer to decrease below the softening temperature.

8. The method of claim 7, wherein supplying ultrasonic energy to the body member includes ultrasonic energy with a linear oscillation at a frequency between about 25 kHz to about 35 kHz for a duration of time between about 1 second to about 30 seconds.

9. The method of claim 7, wherein the softening temperature is defined by a heat distortion temperature (HDT) value, a melt transition temperature (Tm) value, or a glass transition temperature (Tg) value of about 165° F. (about 74° C.) or less.

10. The method of claim 7, further comprising:
applying a layer of a curable adhesive to the tooth bonding surface of the bonding base member to provide an adhesive coated bracket;
positioning the adhesive coated bracket to a desired position on the tooth structure and contacting the adhesive coated bracket with the surface of the tooth structure; and
curing the adhesive to bond the adjustable orthodontic bracket to the tooth structure.

11. A method of manufacturing an adjustable orthodontic bracket comprising a body member, a bonding base member, and a connecting member, comprising:
pre-assembling the adjustable orthodontic bracket by positioning the connecting member between a first faying surface of the body member and a second faying surface of the bonding base member, wherein the connecting member comprises a thermoplastic polymer to provide a pre-assembled bracket;
heating the pre-assembled bracket to increase a temperature of the thermoplastic polymer to a value at or above which the polymer melts; and
lowering the temperature of the thermoplastic polymer to a value at or below which the polymer solidifies,
wherein the value at which the polymer melts is defined as a heat distortion temperature (HDT) value, a melt transition temperature (Tm) value, or a glass transition temperature (Tg) value of about 165° F. (about 74° C.) or less.

12. A method for reducing a bond strength of an orthodontic appliance adhered to a tooth structure with a cured adhesive composition, the method comprising:
treating the orthodontic appliance with ultrasonic energy thereby reducing the bond strength by more than about 20%, wherein the cured adhesive composition comprises a ultrasonic energy responsive filler that softens when subject to ultrasonic energy.

13. The method of claim 12, further comprising removing the orthodontic appliance from the tooth structure, whereby the cured adhesive composition is substantially retained on the tooth structure.

14. The method of claim 12, wherein the ultrasonic energy responsive filler has a heat distortion temperature (HDT) value, a melt transition temperature (Tₘ) value, or a glass transition temperature (T_{g}) value of about 165° F. (about 74° C.) or less.

15. The method of claim 12, wherein the ultrasonic energy responsive filler is distributed uniformly throughout the cured adhesive composition.

16. The method of claim 12, wherein the ultrasonic energy responsive filler is concentrated in a portion of the cured adhesive composition.

17. The method of claim 16, wherein the portion is near or on at least one surface of the cured adhesive composition proximate the orthodontic appliance.

18. The method of claim 16, wherein the portion is near or on at least one surface of the cured adhesive composition proximate the tooth structure.

19. The method of claim 12, wherein treating the orthodontic appliance with ultrasonic energy includes treating with a linear oscillation at a frequency between about 25 to about 35 kHz for a duration of time between about 1 second to about 30 seconds.

20. The method of claim 1, wherein the cured adhesive composition is provided by curing an adhesive composition comprising:
a polymerizable monomer;
a filler component comprising the ultrasonic energy responsive filler; and
a curing initiator.

21. The method of claim 19, wherein the filler component further includes the inorganic filler, where a ratio of the volume percent of the ultrasonic energy responsive filler to the inorganic filler is in a range of about 1:1 to 9:1.
